(19) United States
(12) Patent Application Publication
(10) Pub. No.: US 2023/0409881 A1
(43) Pub. Date: Dec. 21, 2023

(54) METHOD AND DEVICE FOR DATA ABNORMALITY DETECTION

(71) Applicant: Commissariat à l'Energie Atomique et aux Energies Alternatives, Paris (FR)

(72) Inventors: Frédéric HEITZMANN, Grenoble (FR); Miguel-Angel SOLINAS, Grenoble (FR); Marina REYBOZ, Grenoble (FR); Romain COHENDET, Grenoble (FR)

(21) Appl. No.: 18/252,163

(22) PCT Filed: Dec. 27, 2021
(86) PCT No.: PCT/EP2021/087687

§ 371 Date: May 8, 2023

(30) Foreign Application Priority Data
Dec. 28, 2022 (FR) FR2014189

(51) Int. Cl. G06N 3/0455; G06N 3/0895

(52) U.S. Cl. CPC G06N 3/0455; G06N 3/0895

(57) ABSTRACT

The present disclosure relates to a method of anomaly detection using a trained artificial neural network (502) configured to implement at least an auto-associative function for replicating an input data sample at one or more outputs (A), the method comprising: a) injecting an input data sample into the trained artificial neural network (502) in order to generate a first replicated sample at the one or more outputs (A); b) performing at least one reinjection operation; c) computing a first parameter based on a distance between a value of an nth replicated sample present at the one or more outputs and a value of one of the previously injected or reinjected values; and d) comparing the first parameter with a first threshold (δ), and processing the input data sample as an anomalous data sample if the first threshold is exceeded.

### FIELD

The present disclosure relates generally to artificial neural networks, and in particular to a method and device for detecting anomalies in data received by artificial neural networks.

### BACKGROUND

The massive data explosion has deeply modified the way we process data. With the advent of the Internet of Things (IoT) driven by the fifth-generation technology of mobile communication systems, this growth trend is set to accelerate. Artificial intelligence has emerged as a fundamental tool for “big data” processing. In particular, artificial neural networks (ANNs), because of their capacity to represent complex data, are becoming a key tool in a variety of tasks requiring the processing of large quantities of data. Such networks have been found to yield unprecedented results (e.g. computer vision, speech recognition, machine translation, text filtering). Therefore, it is no surprise that embedded ANNs are now found in an increasing number of systems.

Deploying ANNs on edge devices is indeed an alternative to sending the data to datacenters, and is desirable for a number of reasons, including privacy, processing the data in-flight to avoid storage, latency and acceleration.

This massive and fast data flow, and the new usages it entails, have the potential to cause substantial damage. New systems necessarily meet unforeseen situations and, among them, anomalies that could have dramatic consequences (e.g. for autonomous vehicles, smart grid, unsuitable contents filtering). In this context, efficient systems to detect anomalies in data streams are becoming increasingly important. Anomaly detection (AD) using deep ANNs is therefore an active research topic.

AD is a challenging problem. To decide if an input data is an anomaly, a system has to distinguish it from “regular” input data. One intuitive way to make a system capable of detecting anomalies is to train it to recognize what is “regular” data and what is an anomaly, by feeding it with instances of regular and anomalous data. However, such a supervised learning approach requires training data in which each value is labeled as an anomaly or as regular data, and such training data is difficult and costly to obtain. Moreover, this approach is sub-optimal due to class imbalance. Indeed, anomalous data is often more difficult to obtain than regular data, and therefore there is much less of it than the regular data.

### SUMMARY

It is an aim of embodiments of the present disclosure to at least partially address one or more needs in the prior art.

According to one aspect, there is provided a method of anomaly detection using a trained artificial neural network configured to implement at least an auto-associative function for replicating an input data sample at one or more outputs, the method comprising: a) injecting an input data sample into the trained artificial neural network in order to generate a first replicated sample at the one or more outputs of the trained artificial neural network; b) performing at least one reinjection operation into the trained artificial neural network starting from the first replicated sample, wherein each reinjection operation comprises reinjecting a replicated sample present at the one or more outputs into the trained artificial neural network; c) computing a first parameter based on a distance between a value of an nth replicated sample present at the one or more outputs resulting from the (n−1)th reinjection and a value of one of the previously injected or reinjected values; and d) comparing the first parameter with a first threshold, and processing the input data sample as an anomalous data sample if the first threshold is exceeded.

According to one embodiment, the first parameter is an overall distance between the value of an nth replicated sample and a value of the input data sample.

According to one embodiment, the first parameter is an average distance per reinjection.

According to one embodiment, the trained artificial neural network is configured to implement a classification function, one or more further outputs of the trained artificial neural network providing one or more class output values resulting from the classification function.

According to one embodiment, the method further comprises performing adversarial data detection by: e) computing a second parameter based on a distance between values of the one or more class output values present at the one or more further outputs resulting from a reinjection with values of the one or more class output values present at the one or more further outputs resulting from the injection of the input data sample; and f) comparing the second parameter with a second threshold, and processing the input data sample as an adversarial data sample if the second threshold is exceeded.

According to one embodiment, the class output values are Logits.

According to one embodiment, the computing the first parameter and/or second parameter comprises computing one or more of:
the mean squared error distance;
the Manhattan distance;
the Euclidean distance;
the ×² distance;
the Kullback-Leibler distance;
the Jeffries-Matusita distance;
the Bhattacharyya distance; and
the Chernoff distance.

According to one embodiment, processing the input data sample as an anomalous data sample comprises storing the input data sample to a sample data buffer, the method further comprising performing novel class learning on a plurality of input data samples stored in the sample data buffer.

According to a further aspect, there is provided a system for anomaly detection, the system comprising a processing device configured to: a) inject an input data sample into a trained artificial neural network in order to generate a first replicated sample at one or more outputs of the trained artificial neural network, wherein the trained artificial neural network is configured to implement at least an auto-associative function for replicating input samples at the one or more outputs; b) perform at least one reinjection operation into the trained artificial neural network starting from the first replicated sample, wherein each reinjection operation comprises reinjecting a replicated sample present at the one or more outputs into the trained artificial neural network; c) compute a first parameter based on a distance between a value of an nth replicated sample present at the one or more outputs after the (n−1)th reinjection and a value of one of the previously injected or reinjected values; and d) compare the first parameter with a threshold, and processing the input data sample as an anomalous data sample if the threshold is exceeded.

According to one embodiment, the system further comprises: one or more actuators; and an inference module configured to control the one or more actuators only if the input data sample is not detected as an anomalous data sample.

According to one embodiment, the trained artificial neural network is configured to implement a classification function implemented by the inference module, one or more further outputs of the trained artificial neural network providing one or more class output values resulting from the classification function.

According to one embodiment, the processing device is further configured to perform adversarial data detection by: e) computing a second parameter based on a distance between values of the one or more class output values present at the one or more further outputs resulting from a reinjection with values of the one or more class output values present at the one or more further outputs resulting from the injection of the input data; and f) comparing the second parameter with a second threshold, and processing the input data sample as an adversarial data sample if the second threshold is exceeded.

According to one embodiment, the class output values are Logits.

According to one embodiment, the system further comprises a sample data buffer, wherein processing the input data sample as an anomalous data sample comprises storing the input data sample to the sample data buffer, the method further comprising performing novel class learning on a plurality of input data samples stored in the sample data buffer.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 schematically illustrates a multi-layer perceptron ANN architecture according to an example embodiment;

FIG. 2 schematically illustrates an auto-encoder according to an example embodiment;

FIG. 3A is a graph providing a two-dimensional illustration of anomalous and regular data;

FIG. 3B is a graph representing an example of data classified by an ANN classifier;

FIG. 4 is a graph representing an example of adversarial data;

FIG. 5A schematically illustrates a system for anomaly detection according to an example embodiment of the present disclosure;

FIG. 5B schematically illustrates a control system according to an example embodiment of the present disclosure;

FIG. 6 is a flow diagram illustrating operations in a method of anomaly detection according to an example embodiment of the present disclosure;

FIG. 7 is a graph representing an example of three data classes and of reinjection trajectories for anomalous and regular data samples;

FIG. 8 schematically illustrates an ANN architecture comprising a classifier and auto-encoder according to an example embodiment of the present disclosure;

FIG. 9 is a block diagram representing a computing system for implementing a method of anomaly detection according to an example embodiment of the present disclosure;

FIG. 10A represents training of an artificial neural network according to an example embodiment;

FIG. 10B represents data reinjection in an artificial neural network according to an example embodiment;

FIG. 10C represents data reinjection in an artificial neural network according to another example embodiment;

FIG. 11 is a flow diagram representing operations in a method of anomaly detection based on the data reinjection of FIG. 10B or 10C;

FIG. 12 is a flow diagram representing operations in a method anomaly detection according to yet a further example embodiment; and

FIG. 13 illustrates a hardware system according to an example embodiment of the present disclosure.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, techniques for training an artificial neural network, based for example on minimizing an objective function such as a cost function, are known to those skilled in the art, and will not be described herein in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

In the following description, the following terms will be assumed to have the following definitions:
“regular data”: data that falls within a data distribution of a dataset already known to a data processing system. This data distribution is larger than the limits of the known dataset, but the determination of the boundary of this data distribution is one of the challenges to be overcome. Data that is identified as regular data is for example processed as such. This may involve for example applying a classification function to the data, and/or otherwise processing the data on the assumption that it is valid data.
“anomalous data”: any data that is not regular data. Such data, which is sometimes also referred to as abnormal data, deviant data, or outlying data, significantly deviates from the data distribution of the known dataset. For example, anomalous data may correspond to corrupted data, fraudulent or otherwise artificial data such as adversarial data, or data belonging to a class previously unknown to the data processing system;
“adversarial data”: a particular type of anomalous data, corresponding to data that has been specifically generated in order to fool the data processing system into processing it as regular data. For example, adversarial data is crafted in order to take advantage of imprecisions in a classification function implemented by a data processing system. In some cases, an attacker may for example have access to the model applied by the data processing system, known as a so-called white-box attack, meaning that even very small imprecisions in the model can be exploited;
“auto-associative”: the function of replicating inputs, like in an auto-encoder. However, the term “auto-encoder” is often associated with an ANN that is to perform some compression, for example involving a compression of the latent space meaning that the one or more hidden layers contain less neurons than the number of neurons of the input space. In other words, the input space is embedded into a smaller space. The term “auto-associative” is used herein to designate a replication function similar to that of an auto-encoder, but an auto-associative function is more general in that it may or may not involve compression;
“supervised training”: training of a neural network that is based on ground truth labels supplied along with the data to the network;
“self-supervised training”: training of a neural network wherein the input data to the network serves as the sole ground truth, such as when training an auto-associative model.

While in the following description example embodiments are based on a multi-layer perceptron (MLP) ANN architecture, it will be apparent to those skilled in the art that the principles can be applied more broadly to any ANN, fully connected or not, such as any deep-learning neural network (DNN), such as a recurrent neural network (RNN) or convolutional neural network (CNN), or any other type of ANN.

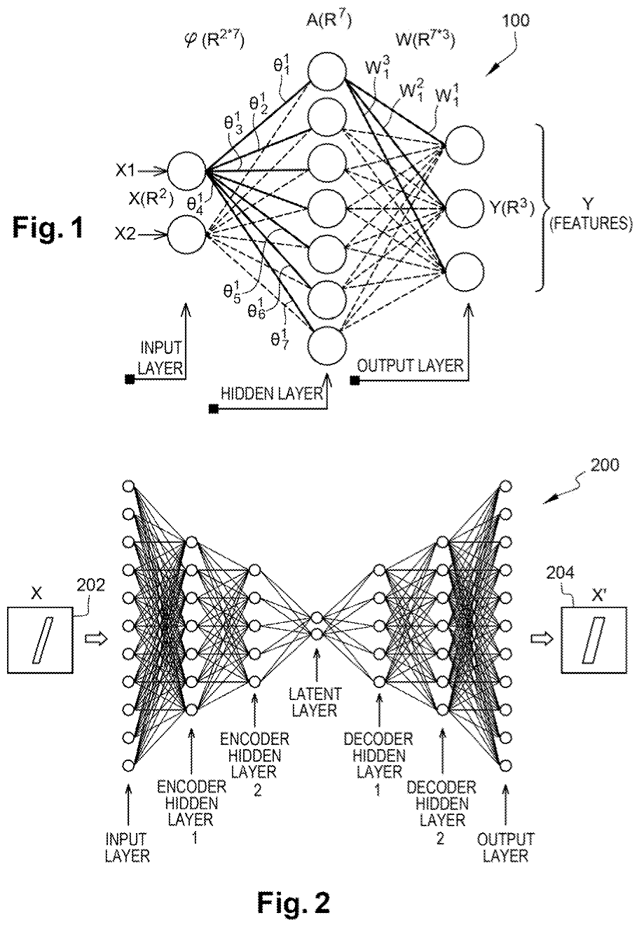

Examples of an MLP and of an auto-encoder will now be described in more detail with reference to FIGS. 1 and 2.

FIG. 1 illustrates a multi-layer perceptron ANN architecture 100 according to an example embodiment.

The ANN architecture 100 according to the example of FIG. 1 comprises three layers, in particular an input layer (INPUT LAYER), a hidden layer (HIDDEN LAYER), and an output layer (OUTPUT LAYER) generating an output Y (FEATURES). In alternative embodiments, there could be more than one hidden layer. Each layer for example comprises a number of neurons. For example, the ANN architecture 100 defines a model in a 2-dimensional space, and there are thus two visible neurons in the input layer receiving the corresponding values X1 and X2 of an input X. The model has a hidden layer with seven output hidden neurons, and thus corresponds to a matrix of dimensions [symbol] ²⁺⁷, because in this example it is a fully connected layer, also called a dense layer. The ANN architecture 100 of FIG. 1 corresponds to a classifying network, and the number of neurons in the output layer thus corresponds to the number of classes, the example of FIG. 1 having three classes.

The mapping Y=ƒ(X) applied by the ANN architecture 100 is a functions aggregation, or aggregate function, comprising an associative function gₙ within each layer, these functions being connected in a chain to map Y=ƒ(X)=gₙ( . . . (g₂(g₁(X)) . . . )). There are just two such functions in the simple example of FIG. 1, corresponding to those of the hidden layer and the output layer.

Each neuron of the hidden layer receives the signal from each input neuron, a corresponding parameter θⱼⁱ being applied to each neuron j of the hidden layer from each input neuron i of the input layer. FIG. 1 illustrates the parameters θ₁¹ to θ₇¹ applied to the outputs of a first of the input neurons to each of the seven hidden neurons.

The goal of the neural model defined by the architecture 100 is to approximate some function F:X→Y by adjusting a set of parameters θ. The model corresponds to a mapping yₚ=ƒ(X; θ), the parameters θ for example being modified during training based on an objective function, such as a cost function. For example, the objective function is based on the difference between ground truth yₜ and output value yₚ. In some embodiments, the mapping function is based on a non-linear projection φ, generally called the activation function, such that the mapping function ƒ can be defined as yₚ=ƒ(X; θ, w)=φ(X; θ)^{T}w, where θ are the parameters of φ, and w is a vector value. In general, a same function is used for all layers, but it is also possible to use a different function per layer. In some cases, a linear activation function φ could also be used, the choice between a linear and non-linear function depending on the particular model and on the training data.

The vector value w is for example valued by the non-linear function φ as the aggregation example. For example, the vector value w is formed of weights W, and each neuron k of the output layer receives the outputs from each neuron j of the hidden layer weighted by a corresponding one of the weights Wⱼ^{k}. The vector value can for example be viewed as another hidden layer with a non-linear activation function φ and its parameters W. FIG. 1 represents the weights W₁¹ to W₁³ applied between the output of a top neuron of the hidden layer and each of the three neurons of the output layer.

The non-linear projection φ is for example manually selected, for example as a sigmoid function. The parameters θ of the activation function are, however, learnt by training, for example based on the gradient descent rule. Other features of the ANN architecture, such as the depth of the model, the choice of optimizer for the gradient descent and the cost function, are also for example selected manually.

FIG. 2 illustrates an auto-encoder 200 according to an example embodiment. The auto-encoder 200 in the example of FIG. 2 corresponds to an example used for imaging processing comprising compression and decompression, although in some cases the compression and decompression operations may be loss-less.

For example, input images 202 are injected into the neurons of an input layer (INPUT LAYER) of the auto-encoder 200. In the case of grey-scale image processing, there is for example an input neuron per pixel of the input image. For other types of images, such as color images, there could be a higher number of input neurons. While for ease of illustration a limited number of neurons are represented in the input layer of FIG. 2, for a 28 by 28 pixel image, the input layer for example comprises 784 neurons.

The auto-encoder 200 also for example comprises a latent layer (LATENT LAYER) comprising the fewest number of neurons of all the layers. In the example of FIG. 2, the latent layer comprises just two neurons. One or more hidden layers between the input layer and the latent layer are encoding layers that progressively reduce the number of neurons. One or more hidden layers between the latent layer and the output layer are decoding layers that progressively increase the number of neurons. In the example of FIG. 2, there are two encoder hidden layers and two decoder hidden layers: a first encoder hidden layer (ENCODER HIDDEN LAYER 1), which for example comprises 500 neurons, and a second encoder hidden layer (ENCODER HIDDEN LAYER 2), which for example comprises 300 neurons, a first decoder hidden layer (DECODER HIDDEN LAYER 1), which for example comprises 300 neurons, and a second decoder hidden layer (DECODER HIDDEN LAYER 2), which for example comprises 500 neurons. Of course, these are merely examples. Generally, the encoding and decoding sides of an auto-encoder are symmetrical, although it would also be possible for these sides to be asymmetric. An output layer (OUTPUT LAYER) provides an output X′ of the network.

The goal of the neural model defined by the auto-encoder 200 is to approximate a function F:X→X′ by adjusting a set of parameters θ. The parameters θ are for example modified during training based on an objective function, such as a cost function.

Like in the ANN 100 of FIG. 1, each neuron of the hidden layers of the auto-encoder 200 receives the signal from each neuron of the previous layer, and each neuron j applies a corresponding parameter θⱼⁱ from each neuron i of the previous layer.

There are two procedures that can be applied to an ANN such as the ANN 100 of FIG. 1, or the ANN 200 of FIG. 2, one being a training or backward propagation procedure in order to learn the parameters θ, and the other being an inference or feedforward propagation procedure, during which input values X flow through the function, and are multiplied by the intermediate computations defining the mapping function ƒ, in order to generate an output Y in the case of the classifying ANN 100 of FIG. 1, or an output X′ in the case of the auto-encoder ANN 200 of FIG. 2.

It should be noted that the training of an auto-encoder does not involve the use of labelled training data, as such an ANN is simply trained to replicate, at the output of the network, the values at the input of the network. Thus, an auto-encoder is trained via self-supervised learning.

Once an autoencoder has been trained, it can make inferences, in other words reproducing its learnt input-output mapping for new incoming data. In the case of an MLP classifier like the one of FIG. 1, performing an inference involves feeding into the ANN a new input sample, e.g. an input image, and observing the classification result in the output layer resulting from the feedforward propagation, e.g. the class that the ANN associates with a new image. In the case of an autoencoder like the one of FIG. 2, performing an inference involves the process of encoding and decoding an input to obtain its reconstruction.

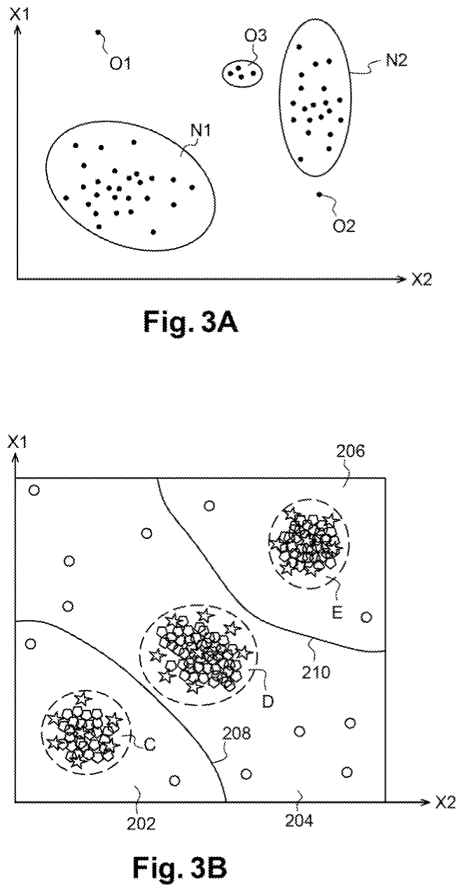

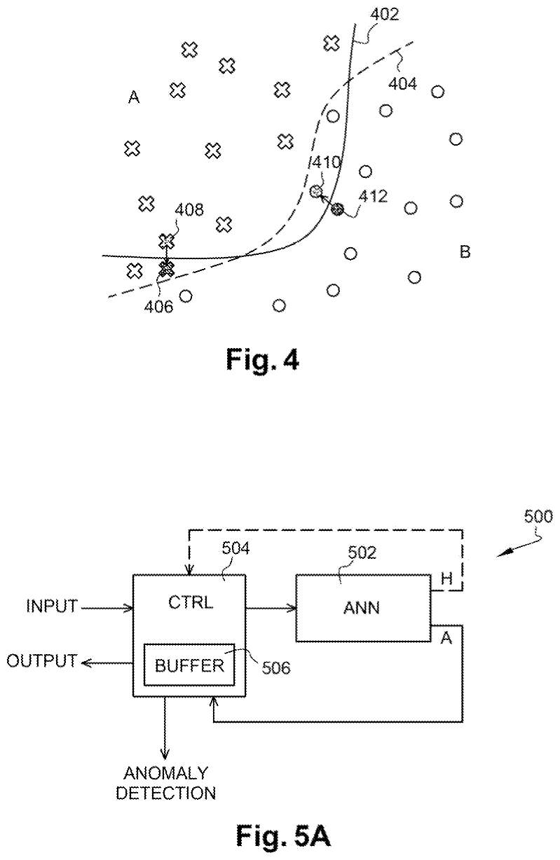

A data processing system comprising for example the MLP ANN 100 of FIG. 1, the auto-encoder 200 of FIG. 2, or other type of neural network, can be subjected to anomalous data, as will now be described in more detail with reference to FIGS. 3A, 3B and 4.

FIG. 3A is a graph providing an illustration of anomalous and regular data, based on a two-dimensional input space X1, X2. The definition of anomalies is for example discussed in detail in the publication by Chalapathy and Chawla entitled “Deep learning for anomaly detection: A survey”, Jan. 24, 2019, and FIG. 3A substantially reproduces FIG. 3 of that publication. Anomalies are data that significantly deviates from an original set of data. For example, regions N1 and N2 of FIG. 3A are regions where the majority of observations are located, and are thus considered as normal or regular data. On the contrary, data points O1, O2 and region O3 are located further away from the bulk of the data points, and are thus considered as anomalies. Such anomalies may arise for a broad range of reasons, such as malicious actions, system failures or intentional fraud.

FIG. 3B is a graph representing an example of data classified by an ANN classifier, based on a similar two-dimensional input space X1, X2 as the example of FIG. 3A. FIG. 3B provides in particular an example of a model that classifies elements into three classes. For example, an artificial neural network, such as the ANN 100 of FIG. 1, is trained to map input samples defined as points represented by pairs of input values X1 and X2 into one of three classes C, D and E.

As an example, X∈ [symbol] ², where X1 is a weight feature, X2 is a corresponding height feature, and the function yₚ=ƒ(X; θ) maps the height and weight samples into a classification of cat (C), dog (D) or elephant (E). In other words, the ANN is trained to define a non-linear boundary between cats, dogs and elephants based on a weight feature and a height feature of an animal, each sample described by these features falling in one of the three classes.

The space defined by the value X1 in the y-axis and X2 in the x-axis is divided into three regions 202, 204 and 206 corresponding respectively to the classes C, D and E. In the region 202, any sample has a higher probability of falling in the class C than in either of the other classes D and E, and similarly for the regions 204 and 206. A boundary 208 between the C and D classes, and a boundary 210 between the D and E classes, are the class decision boundaries. The thickness of these boundaries represents the uncertainty of the model, that is to say that, along these boundaries, samples have equal probabilities of belonging to each of the two classes separated by the boundary.

The pentagons in FIG. 3B represent learnt data points, and dashed circles in each region 202, 204, 206 indicate the limit of the samples. Stars within each of the dashed circles represent new but regular input data that is appropriately classified by the network. The circles in FIG. 3B represent new anomalous data. These anomalies reveal important insights about the data and often convey valuable information about the data. Therefore, the use of anomaly detection to be able to accurately identify such anomalies is a key object in various decision-making systems.

FIG. 4 is a graph representing an example of adversarial data, again based on a two-dimensional input space similar to the one of FIGS. 3A and 3B. The example of FIG. 4 is based on an internet publication by N. Papernot and I. Goodfellow, “Breaking things is easy”, cleverhans-blog, Dec. 16, 2016. Adversarial examples are a particular case of anomalies. According to a publication by Goodfellow et al., 2014, entitled “Explaining and harnessing adversarial examples”, adversarial examples are “inputs formed by applying small but intentionally worst-case perturbations to examples from the dataset, such that the perturbed input results in the model outputting an incorrect answer with high confidence”. One common explanation of the phenomenon is based on the usually imperfect matching between task decision boundaries and model decision boundaries, as illustrated in FIG. 4, as will now be explained.

A solid curve 402 in FIG. 4 represents a model decision boundary between classes A and B, in other words a boundary that has been learnt by an ANN, whereas a dashed curve 404 in FIG. 4 represents a task decision boundary, in other words the real class boundary between the classes A and B. Crosses in FIG. 4 represent the training points for class A, and circles the training points for class B.

A cross 406 in FIG. 4 represents a first adversarial example corresponding to the displacement of a test point 408 for class A across the model decision boundary 402, without crossing the task decision boundary 404. Thus, the adversarial example 406 is incorrectly identified as falling within the class B.

A circle 410 in FIG. 4 represents a second adversarial example corresponding to the displacement of a test point 412 for class B across the model decision boundary 402, without crossing the task decision boundary 404. Thus, the adversarial example 410 is incorrectly identified as falling within the class A.

Being able to accurately detect the presence of adversarial input data is of high importance, for example for system security.

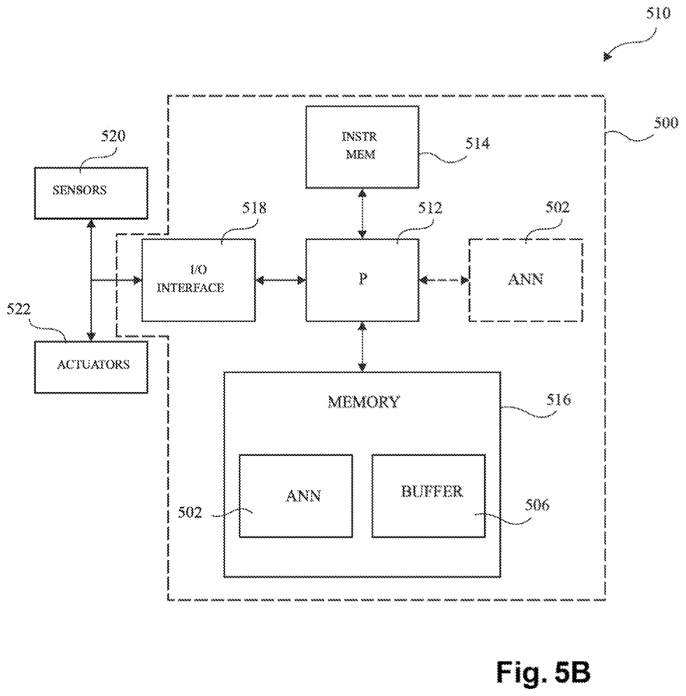

FIG. 5A is a block diagram representing a system 500 configured to implement a method of anomaly detection according to an example embodiment of the present disclosure.

The system 500 comprises an artificial neural network 502 that applies at least an auto-associative function, and generates at one or more outputs, one or more auto-associative output values A. In some embodiments, the ANN 502 also applies a hetero-associative, or classification function, and generates, at one or more outputs, one or more hetero-associative output values H. The system 500 further comprises a control circuit (CTRL) 504, which for example comprises a memory buffer (BUFFER) 506.

The control circuit 504 for example has an input configured to receive an input data sample (INPUT). Furthermore, the control circuit 504 is for example configured to receive the one or more auto-associative output values A from the ANN 502. In some embodiments, the control circuit 504 also receives the one or more hetero-associative output values H from the ANN 502. As will be described in more detail below, the auto-associative output values A are for example provided to the control circuit 504 in order to be reinjected as part of a detection method for anomalous data. As will also be described in more detail below, the hetero-associative output values H are for example provided to the control circuit 504 for the purposes of detection adversarial examples.

The control circuit 504 also for example comprises an output for providing an anomaly detection signal (ANOMALY DETECTION) indicating when an anomaly has been detected, and/or an output providing an output signal (OUTPUT) generated by the ANN 502.

Either or both of the ANN 502 and control circuit 504 may be implemented by dedicated hardware, or by a computer program executed by one or more processors, or by a combination of hardware and software, as will now be described in more detail with reference to FIG. 5B.

FIG. 5B is a block diagram representing a control system 510 according to an example embodiment of the present disclosure. For example, the control system 510 comprises the system 500 of FIG. 5A implemented by a computation device. In some embodiments, the computation device 500 is an Edge AI (Artificial Intelligence) device, which is a device combining artificial intelligence processing capabilities with Edge computing.

The computation device 500 for example comprises a processing device (P) 512 having one or more CPUs (Central Processing Units) under control of instructions stored in an instruction memory (INSTR MEM) 514. Alternatively, rather than CPUs, the computation device 500 could comprise one or more NPUs (Neural Processing Units), or GPUs (Graphics Processing Units), under control of the instructions stored in the instruction memory 514. The processing device 512, under control of instructions from the instruction memory 514, is for example configured to implement the functions of the control circuit 504 of FIG. 5A.

A further memory (MEMORY) 516, which may be implemented in a same memory device as the memory 514, or in a separate memory device, for example stores the artificial neural network ANN 502, such that a computer emulation of this ANN is possible. The ANN 502 is for example an MLP similar to the one described in relation to FIG. 1, or another type of ANN having a learning function.

For example, the ANN 502 is fully defined as part of a program stored by the instruction memory 514, including the definition of the structure of the ANN, i.e. the number of neurons in the input and output layers and in the hidden layers, the number of hidden layers, the activation functions applied by the neuron circuits, etc. Furthermore, parameters of the ANN learnt during training, such as its parameters and weights, are for example stored in the memory 516. In this way, the ANN 502 can be trained and/or operated within the computing environment of the computation device 500.

The memory 516, or another memory device coupled to the processing device 512, for example comprises the memory buffer (BUFFER) 506.

Rather than the ANN 502 being implemented entirely by software emulations, it would alternatively be possible for the ANN 502 to be implemented at least partially by one or more hardware circuits represented by a dashed rectangle in FIG. 5B.

The control system 510 also for example comprises an input/output interface (I/O INTERFACE) 518 via which new stimuli is for example received, and from which results data can be output from the ANN. In particular, the control system 510 for example comprises one or more sensors (SENSORS) 520, and one or more actuators (ACTUATORS) 522, coupled to the input/output interface 518. In some embodiments, the sensors 520 provide input data samples, and the computation device 500 is configured to perform anomaly detection on the input data samples, as described herein. The computation device 500 is also for example configured to control the one or more actuators 522 as a function of a result of the anomaly detection. For example, if one or more input data samples are found to correspond to regular data, the computation device 500 is for example configured to perform inference on these data samples using the ANN 502, or using another ANN implemented in a similar manner to the ANN 502, and then to control the one or more actuators as a result of the inference.

The one or more sensors 520 for example comprise one or more image sensors, depth sensors, heat sensors, microphones, or any other type of sensor. For example, the one or more sensors 520 comprise an image sensor having a linear or 2-dimensional array of pixels. The image sensor is for example a visible light image sensor, an infrared image sensor, an ultrasound image senor, or an image depth sensor, such as a LIDAR (LIght Detection And Ranging) image sensor. In this case, input data samples captured by the sensors 520 and provided to the computation device 500 are images, and the computation device 500 is configured to perform image processing on the images in order to determine one or more actions to be applied via the actuators 522. Anomaly detection is important in such image processing applications in order, for example, to verify that captured images have not been corrupted or modified fraudulently, which could have a safety impact, particularly if for example the image processing is relied upon for controlling autonomous systems, such as in a vehicle.

The one or more actuators 522 for example comprise a robotic system, such as a robotic arm trained to pull up weeds, or to pick ripe fruit from a tree, an automatic steering or breaking systems in a vehicle, or an electronic actuator, which is for example configured to control the operation of one or more circuits, such as waking up a circuit from sleep mode, causing a circuit to enter into a sleep mode, causing a circuit to generate a text output, to perform a data encoding or decoding operation, etc.

According to a further example, the one or sensors are interior and/or exterior temperature sensors of a building heating and/or cooling system, comprising for example a heat pump as the main energy source. In such a case, the one or more actuators are for example activation circuits that activate the heating or cooling systems. Continuous learning is important in such applications in order to be able to adapt to previously unknown conditions, such as extreme temperatures, the occupants of the building leaving on vacation, the routines of the occupants of the building being affected by strike action, etc. Anomaly detection is for example important in order to be able to detect when input data is not longer reliable, for example due to a faulty sensor, or another defective element in the system.

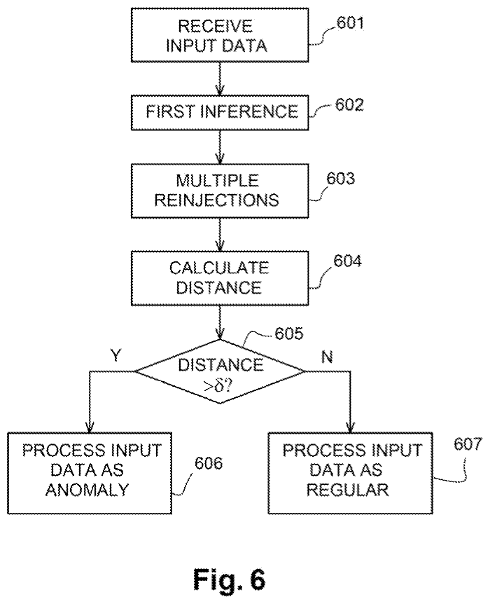

Operation of the anomaly detection system 500 of FIGS. 5A and 5B will now be described in more detail with reference to FIG. 6.

FIG. 6 is a flow diagram illustrating operations in a method of anomaly detection according to an example embodiment of the present disclosure. This method is for example implemented by the system 500 of FIGS. 5A and 5B, and in particular by the control circuit 504 and/or processing device 512. The method is for example applied each time a new input data sample INPUT is received by the control circuit 504.

In an operation 601 (RECEIVE INPUT DATA), an input data sample is received. For example, this input data sample corresponds to the input signal INPUT of the control circuit 504 of FIG. 5A. Depending on the application, this input data sample may correspond to any of a broad range of signal types, including but not limited to signal captured by one or more sensors, such as an image, audio sequence, accelerometer reading, temperature reading, etc.

In an operation 602 (FIRST INFERENCE), the input data sample is applied to a trained ANN in order to perform a first inference. The trained ANN is configured to implement at least an auto-associative function for replicating input samples at the one or more outputs. For example, the trained ANN is the ANN 502 of FIG. 5A or FIG. 5B. Generating the first inference for example involves injecting, by the control circuit 504, the input data sample into the ANN 502, and receiving in response a replicated sample at the one or more outputs of the ANN 502.

The ANN 502 has for example been trained based on a set of training data using supervised and/or non-supervised learning. In particular, the auto-associative function of the ANN 502 has for example been trained by self-supervised learning. The model of the auto-associative function has for example been trained to learn to reconstruct the data of a dataset corresponding to what is to be considered as “regular” data. In other words, this training dataset does not comprise anomalous data, but only regular data. During training, the parameters of the ANN 502, including the weights and bias, are for example iteratively updated until the model has learnt a function to transform an input into an output. For example, as known by those skilled in the art, this may involve defining a loss function that represents an unhappiness with the model's outcomes; that is, the loss is high when the model is doing a poor job and low when it is performing well. Typically, the learning consists in minimizing the loss function by modifying the model parameters for it to converge towards a good mapping between the inputs and the outputs. The parameter modification is for example carried out using a technique known as gradient descent. An error signal is propagated backwards through all the neurons in order to iteratively adjust the internal parameters of the model.

Once this type of training has been completed, the ANN 502 is ready to be employed for the purposes of anomaly detection, without involving a new learning stage for each new incoming data as is required in some prior art solutions, thereby significantly reducing the computation time.

If the ANN 502 also implements a classification function, this hetero-associative portion has for example been trained using supervised learning, for example based on labelled training data from the dataset. During training, pairs of data are presented to the network; e.g. X can be images and Y the labels describing the class they belong to. The classifier is taught to map the images to theirs corresponding classes. More generally, the classifier is taught to map input samples of the training dataset to the associated labels.

In an operation 603 (MULTIPLE REINJECTIONS), n reinjection operations are for example performed into the trained artificial neural network, starting from the replicated sample resulting from the injection of the input data sample in operation 602. Each reinjection operation comprises reinjecting into the trained ANN a replicated sample present at the one or more outputs into the trained artificial neural network. For example, the control circuit 504 of FIG. 5A is configured to reinject the one or more auto-associative values A back into the ANN 502. The value of n is for example equal to at least 1, and in some cases to at least 3, such as between 3 and 20.

In an operation 604 (CALCULATE DISTANCE), an overall distance is calculated between the value of nth replicated sample, i.e. the sample present at the one or more outputs of the trained ANN resulting from the nth reinjection, and a value of one of the previously injected or reinjected values. For example, the distance is calculated with respect to the input data sample, or with respect to the replicated sample resulting from injection into the ANN of the input data sample. There are a variety of distance metrics that could be used in order to generate the distance, and those skilled in the art will understand how to select an appropriate metric based, for example, on the type of samples being processed. For example, one or more of the following distance metrics could be used: the mean squared error (MSE) distance; the Manhattan distance; the Euclidean distance; the χ² distance; the Kullback-Leibler distance; the Jeffries-Matusita distance; the Bhattacharyya distance; and the Chernoff distance. In the case that the data samples are images, the MSE distance is for example the simplest metric to use. The MSE for a color image is, for example, simply the sum of squared differences between intensity values. The distance is for example calculated by the control circuit 504.

In an operation 605 (DISTANCE>δ?), the distance calculated in operation 604 is compared to a threshold δ. If this threshold is exceeded (Y), in an operation 606 (PROCESS INPUT DATA AS ANOMALY), the input data sample is for example processed as an anomaly. For example, this involves generating, by the control circuit 504, the anomaly detection signal indicating that an anomaly has been detected. Additionally or alternatively, the input data value is stored to the buffer 506, where it is for example added to a list of identified anomalies. In some embodiments, this list of anomalies is used as a basis for new class learning when the number of samples in the list reaches a certain number that permits such an operation. In particular, if some or all of the anomaly samples are clustered, they may correspond to one or more new class that can be learnt using a supervised learning technique, as known by those skilled in the art. Some or all of the anomalies may of course also be relatively dispersed within the input space, meaning that no new class can be identified.

If in operation 605, the threshold δ is not exceeded (N) by the distance calculated in operation 604, in an operation 607 (PROCESS INPUT DATA AS REGULAR), the input data sample is for example processed as a regular data sample. For example, this may mean that the control circuit 504 is configured to generate the output signal OUTPUT either validating the input data sample as regular data, or providing a result based on this data. For example, in the case that the ANN 502 performs a classification function, the hetero-associative output H resulting from the injection of the input data sample may be supplied as the output signal OUTPUT.

While in the example of FIG. 6 only an overall distance is calculated in operation 605 after the n reinjections have been performed, in alternative embodiments it would be possible to additionally perform one or more distance calculations after each reinjection, each distance for example being calculated with respect to the input data sample, or with respect to the reinjected data sample that resulted in the replicated data sample at the one or more outputs of the trained ANN. For example, a distance 1 is calculated based on the result of the first inference (operation 602), a distance 2 based on the result of the first reinjection, and so on and so forth, up to a distance (n+1) resulting from this nth reinjection. These intermediate distances for example permit the number of reinjections to be varied as a function of the evolution in the distance and/or in the speed of variation.

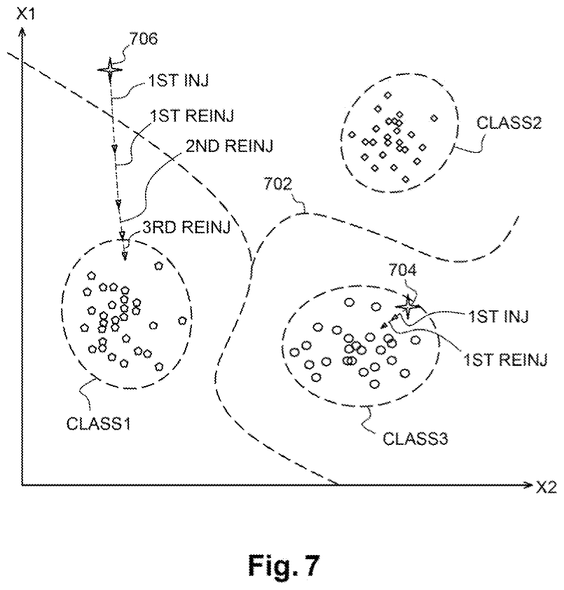

The anomaly detection system 500 of FIGS. 5A and 5B, and the anomaly detection method of FIG. 6, are based on an observation made by the present inventors that the variations in the trajectory followed by auto-associative samples upon reinjections is different between regular data and anomalous data. This will now be described in more detail with reference to FIG. 7.

FIG. 7 is a graph representing an example of three data classes and of reinjection trajectories for anomalous and regular data samples. FIG. 7 is based on a two-dimensional input space X1, X2 similar to that of FIGS. 3A and 3B. There are for example three data classes CLASS 1, CLASS 2 and CLASS 3 that have been learnt by the model of the ANN, such as the ANN 502 of FIG. 5A or 5B. The training data is shown in FIG. 7, with pentagonal dots representing the samples of the class 1, diamond dots representing the samples of the class 2, and round dots representing the samples of the class 3. The class boundaries of the model are represented by a dashed curve 702.

A star 704 provides an example of a new data sample corresponding to regular data within the class 3. After the first injection (1ST INJ) of this new data sample into the trained ANN, the resulting replicated sample at the output of the ANN is at a point closer to the center of the class 3. After a first reinjection (1ST REINJ) of the replicated sample into the trained ANN, the resulting replicated sample at the output of the ANN is at a point still closer to the center of the class 3.

A star 706 provides an example of a new data sample corresponding to anomalous data within the class 2 decision boundaries, but far from any of the trained classes. In this case, after the first injection (1ST INJ) of this new data sample into the trained ANN, the resulting replicated sample at the output of the ANN is at a point closer to the class 1, and has moved by a relatively large jump. After a first reinjection (1ST REINJ) of the replicated sample into the trained ANN, the resulting replicated sample at the output of the ANN is at a point still closer to the class 1. This is similar for the second and third reinjections (2ND REINJ, 3RD REINJ).

It will be noted that the step size of the auto-associative data values upon each reinjection are significantly bigger in the case of anomalous data samples when compared to regular data samples. This results from the fact that reinjecting the input, which for example involves encoding and decoding the data sample multiple times, makes it incrementally converge towards the inherent data structure that was learnt by the trained ANN. The speed at which this occurs is greater for anomalous data, as these start from points that are far from the learnt replications. For example, by comparing the total trajectory distance with a threshold, a reliable mechanism for anomaly detection can be provided.

However, while the use of a distance measurement has been described in order to discriminate between the different behavior of the anomalous data samples with respect to regular data samples, another parameter could be used that is calculated based on the distance, such as the speed of variation, calculated for example as the average of the distances calculated for each injection or reinjection.

The threshold δ that is used to discriminate between regular and anomalous data is for example calculated based on the dataset used to train the ANN. For example, a plurality of the data samples of the test data of the training dataset, i.e. data samples that are not used for the actual learning, but for testing the trained ANN, are reinjected n times to measure the average of the overall distances of convergence calculated for each of the data samples. Similarly, the exercise is for example repeated for a plurality of anomalies, which could correspond simply to noise if anomalous data are not available, which are each reinjected n times to measure the average distance of convergence towards the learnt data distribution. The parameter δ can then be set to a value allowing a discrimination between distances of the anomalous and regular samples, such as the distance half-way between each average distance. In some embodiments, this threshold parameter δ is updated as a function of new data processed by the system. For example, if new data is determined to be regular data, the calculated distance for this new data can be used to update the parameter δ in order to take into account any general shifts in the data. Furthermore, in the case that no training dataset is available, such as if the ANN has only an auto-associative function and no hetero-associative function, it would also be possible to calculate this threshold parameter δ using synthetic data obtained by sampling the data distribution learnt by the trained ANN.

In some embodiments, the threshold δ is also set based on a risk criterion, that is to say the number of false positive anomalies (i.e. regular data detected as anomalies) that is deemed acceptable for the given application. For example, based on the training data set, the threshold δ can be selected in order to target a given rate of false positives, such as 1%. In such a case, the threshold δ is for example chosen such that 99% of the regular data values are not identified as anomalies.

It will be noted that, in the example of FIG. 7, the number of reinjections n in the case of the regular data sample and in the case of the adversarial data sample are not the same. Indeed, in some embodiments, the number n is fixed, while in other embodiments it may be variable as a function of, for example, a detected speed of convergence. For example, if it is detected that the speed is very slow, e.g. the distance between consecutive reinjections has fallen below a given threshold, the reinjections are stopped more quickly than if it is determined that the speed is relatively fast. In some embodiments, reinjections may be performed until it is detected that movement has stopped entirely, in other words until the replicated sample at the auto-associative output resulting from a reinjection is equal to the input sample, implying a distance equal to zero.

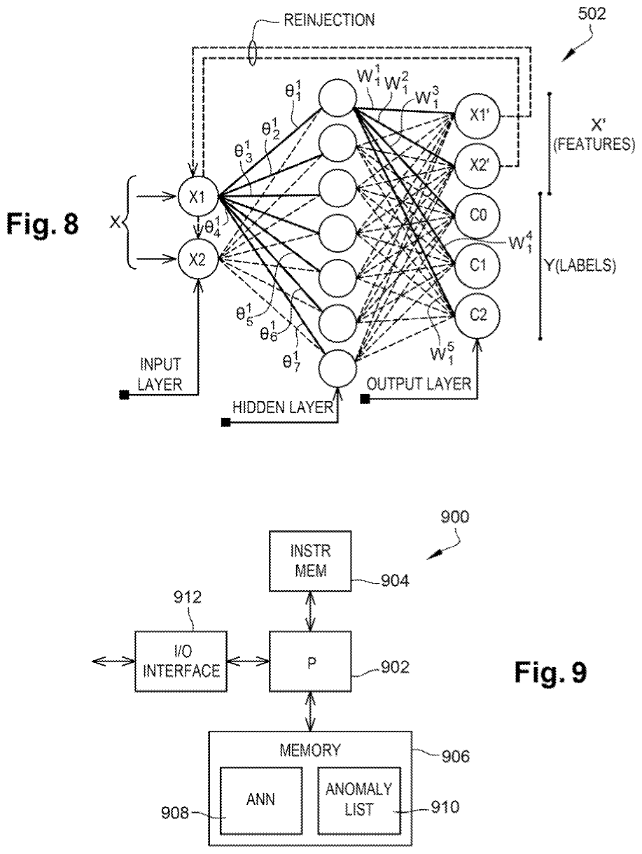

FIG. 8 schematically illustrates an example implementation of the ANN 502 of FIG. 5A or 5B in the case that it comprises both auto-associative and hetero-associative functions.

The ANN 502 of FIG. 8 is similar to the ANN 100 of FIG. 1, but additionally comprises an auto-associative portion capable of replicating the input data using neurons of the output layer. Thus, this model performs an embedding from [symbol] ^{m}→ [symbol] ^{m}×{1, 2, . . . c}, with m the features, and c the classes Like in the example of FIG. 1, in the ANN 502 of FIG. 8, each input sample has two values, corresponding to a 2-dimensional input space, and there are thus also two corresponding additional output neurons (FEATURES) for generating an output pseudo sample (X′) replicating the input sample. For example, each input sample X is formed by a pair of values X1, X2, and the ANN 502 classifies these samples as being either in a class C0, C1 or C2, corresponding to the label (LABELS) forming the output value Y.

The auto-associative portion of the ANN 502 behaves in a similar manner to an auto-encoder. As indicated above, the term “auto-associative” is used herein to designate a functionality similar to that of an auto-encoder, except that the latent space is not necessarily compressed. Furthermore, like for the training of an auto-encoder, the training of the auto-associative part of the ANN may be performed with certain constraints in order to avoid the ANN converging rapidly towards the identity function, as well known by those skilled in the art.

In the example of FIG. 8, the network is common for the auto-associative portion and the classifying portion, except in the output layer. Furthermore, there is a connection from each neuron of the hidden layer to each of the neurons X1′ and X2′ of the output layer. However, in alternative embodiments, there could be a lower amount of overlap, or no overlap at all, between the auto-associative and classifying portions of the ANN 502. Indeed, in some embodiments, the auto-associative and hetero-associative functions could be implemented by separate neural networks. In some embodiments, in addition to the common neurons in the input layer, there is at least one other common neuron in the hidden layers between the auto-associative and classifying portions of the ANN 502. A common neuron implies that this neuron supplies its output directly, or indirectly, i.e. via one or more neurons of other layers, to at least one of the output neurons of the auto-associative portion and at least one of the output neurons of the classifying portion.

As illustrated in FIG. 8, the auto-associative outputs of the ANN are reinjected (REINJECTION) back to the inputs of the ANN. Such a reinjection is for example performed by the control circuit 502 as described above for the purposes of anomaly detection. Thus, the auto-associative portion of the ANN model is used as a recursive function, in that its outputs are used as its inputs.

FIG. 9 is a block diagram representing a computing system 900 for implementing a method of anomaly detection according to an alternative embodiment to that of FIG. 5B. In particular, FIG. 9 represents an example in which the ANN 502 and control circuit 504 of FIG. 5A are implemented in software.

For example, the computing system 900 comprises a processing device (P) 902 comprising one or more CPUs (Central Processing Units) under control of instructions stored in an instruction memory (INSTR MEM) 904. Alternatively, rather than CPUs, the computing system could comprise one or more NPUs (Neural Processing Units), or GPUs (Graphics Processing Units), under control of the instructions stored in the instruction memory 904. These instructions for example cause the functions of the control circuit 504, as described above with reference to FIGS. 5 and 6, to be implemented.

The computing system 900 also for example comprises a further memory (MEMORY) 906, which may be implemented in a same memory device as the memory 904, or in a separate memory device. The memory 906 for example stores the ANN 502 in a memory region 908, such that a computer emulation of this ANN is possible. For example, the ANN 502 is fully defined as part of a program stored by the instruction memory 904, including the definition of the structure of the ANN, i.e. the number of neurons in the input and output layers and in the hidden layers, the number of hidden layers, the activation functions applied by the neuron circuits, etc. Furthermore, parameters of the ANN learnt during training, such as its parameters and weights, are for example stored in the regions 908 of the memory 906. In this way, the ANN 502 can be trained and operated within the computing environment of the computing system 900. A further memory region 910 of the memory 906 for example implements the buffer 506 of FIG. 5A storing the anomaly list (ANOMALY LIST).

In some embodiments, the computing system 900 also comprises an input/output interface (I/O INTERFACE) 912 via which new input data samples are for example received, for example from sensors like the sensors 520 of FIG. 5B and from which results data can be output from the ANN 502, for example for controlling actuators like the sensors 522 of FIG. 5B.

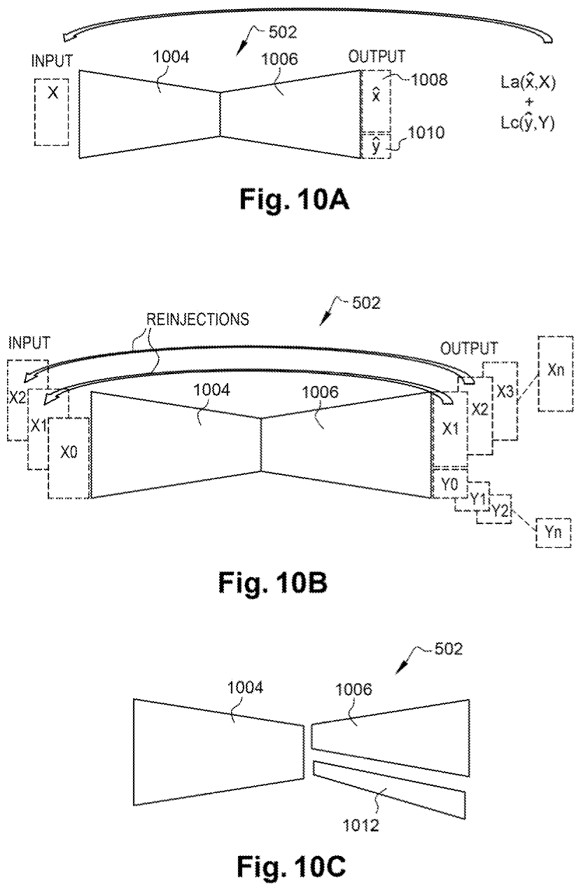

FIG. 10A represents training of the artificial neural network 502 according to an example embodiment. In the example of FIG. 10A, the network 502 comprises an encoding portion 1004, and a decoding portion 1006. During training, input data samples X are supplied to the input (INPUT) of the encoding portion 1004, and decoding portion provides, at its output (OUTPUT), first outputs 1008 corresponding to reconstruction values resulting from the auto-associative function implemented by the network 502. These outputs are used in a loss function La(\hat{x}, X) in FIG. 10A, where La(\hat{x}, X) is the Reconstruction loss, which reflects the difference between the original input X and the output \hat{x}. The decoding portion 1006 also has one or more outputs 1010 corresponding to classification values resulting from a hetero-associative function implemented by the network 502. These outputs are used in a loss function Lc(ŷ, Y) in FIG. 10A, where Lc(ŷ, Y) is the Classification loss, which reflects the difference between the ground truth label Y and the predicted label ŷ during training. For example, during training, the two losses La and Lc are added together for joint learning of the auto- and hetero-associative functions.

FIG. 10B represents data reinjection (REINJECTIONS) in the artificial neural network 502 according to an example embodiment during anomaly detection. Each new incoming data sample X0, X1, X2, . . . , X(n−1) is reinjected once or multiple times to generates auto-associative outputs X1, X2, X3, . . . , Xn, and its variations upon its reconstructions are measured in order to detect anomalies. Predicted labels Y0, Y1, Y2, . . . , Yn, are also for example generated by the classification function.

FIGS. 10A and 10B correspond to a case in which the classification function is applied to the output of the decoder portion 1006. In alternative embodiments, there may be an earlier separation between the auto and hetero-associative functions, an example of which is illustrated in FIG. 10C.

FIG. 10C illustrates a case in which the classification function is applied to the latent space at the output of the encoder portion 1004, in parallel with the decoder portion 1006. Training and data reinjection for anomaly detection based on the model of FIG. 10C is for example the same as for FIGS. 10A and 10B. An advantage of the model of FIG. 10C is that the separation of the classification and auto-associative functions leads to a certain level of independence between the models during training. For example, the model of FIGS. 10A and 10B is particularly effective for processing black and white or grey-scale images, whereas the model of FIG. 10C is particularly effect for processing color images, or for cases in which Logits are to be used as part of the anomaly detection.

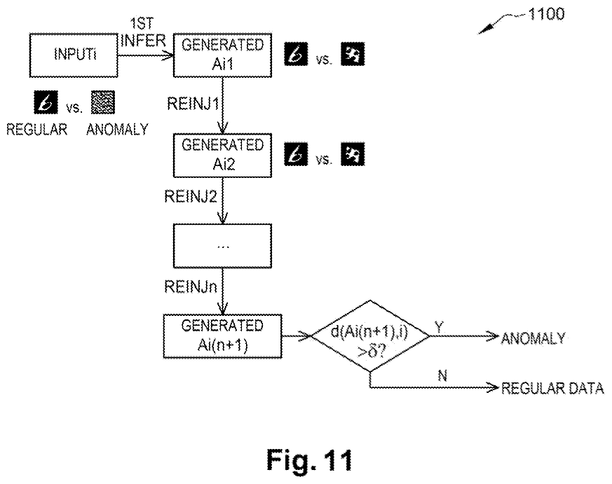

FIG. 11 is a flow diagram representing operations in a method 1100 of anomaly detection according to a further example embodiment, which is similar to the method of FIG. 6. This method 1100 is for example implemented by the anomaly detection system 500 of FIG. 5A or 5B. Example of data samples in the form of images are shown in FIG. 11, by these are merely for illustrative purposes, any type of data sample being possible.

The input data sample INPUTi is applied to the ANN to perform a first inference (1ST INFER) and generate a first auto-associative output Ai1 (GENERATED Ai1). One or multiple reinjections REINJ1 to REINJn are then performed, each resulting in a corresponding auto-associative output Ai2 to Ai(n+1) (GENERATED Ai2, GENERATED Ai(n+1)). The overall distance d(Ai(n+1),i) in other words the distance between the final auto-associative output Ai(n+1) and the input data sample INPUTi, is for example compared to the threshold δ, and if the threshold is exceeded (Y), the input data sample INPUTi is determined to be an anomaly (ANOMALY), and if the threshold is not exceeded (N), the input data sample INPUTi is determined to be a regular data (REGULAR DATA).

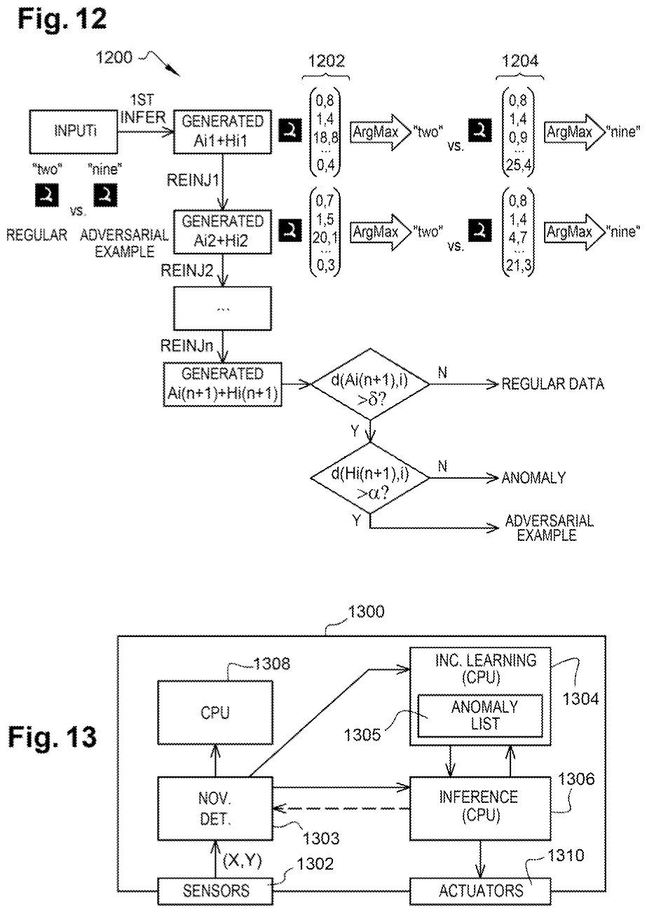

FIG. 12 is a flow diagram representing operations in a method 1200 for anomaly detection according to yet a further example embodiment. This method 1200 is for example implemented by the anomaly detection system 500 of FIG. 5A or 5B. Examples of data samples in the form of images are shown in FIG. 12, by these are merely for illustrative purposes, any type of data sample being possible.

The method 1200 is for example similar to the method 1100 of FIG. 11, but also permits an adversarial example to be distinguished from other types of anomalies. In particular, it has been found that the method of FIG. 11 permits anomaly detection for a broad range of anomalies, including the majority of adversarial examples, but does not provide an indication of when adversarial examples are detected. The presence of adversarial examples may be the result of a targeted attack against a neural network, and therefore for some applications it would be desirable to provide a means of detection, in order for example to generate an alert signal or apply a counter measure.

Like in the method 1100, in the method 1200, the input data sample INPUTi is applied to the ANN to perform a first inference (1ST INFER) and generate a first auto-associative output Ai1. However, additionally, a first hetero-associative output Hi1 is generated (GENERATED Ai1+Hi1). This output Hi1 is for example in the form of Logits, corresponding to the raw values of the predictions or outputs of the model, i.e. prior to normalization. In particular, as known by those skilled in the art, Logits are generated by the last pre-activation layer in a deep ANN classifier, this layer often being referred to as the Logits layer. It is proposed herein to use the variations of Logits as a mechanism to detect adversarial examples. For example, the output H of the ANN 502 in FIG. 5A or 5B is for example provided to the control circuit 504 in order for the Logits to be taken into account during the anomaly detection method. FIG. 12 illustrates some examples of Logits vectors 1202 for the case of regular data, and Logits vectors 1204 for the case of an adversarial example.

Multiple reinjections REINJ1 to REINJn are then performed, each resulting in a corresponding auto-associative output Ai2 to Ai(n+1), and a corresponding hetero-associative output (GENERATED Ai2+Hi2, GENERATED Ai(n+1)+Hi(n+1)).

Like in the method 1100, the distance d(Ai(n+1),i), in other words the distance between the final auto-associative output Ai(n+1) and the input data sample INPUTi, is compared to the threshold δ, and if the threshold is not exceeded (N), the input data sample INPUTi is determined to be a regular data (REGULAR DATA). However, in the method of FIG. 12, if the threshold is exceeded (Y), a further step is performed in order to distinguish between an adversarial example and other types of anomalies. For example, a further distance d(Hi(n+1),Hi1) is calculated, this distance for example corresponding to the distance between the hetero-associative outputs Hi(n+1) and Hi1. This distance can for example be determined using the same techniques as for the calculation of the distance in operation 604 of FIG. 6. The distance is then compared to a further threshold α, and if the threshold α is exceeded (Y), the input data sample INPUTi is considered to be an adversarial example (ADVERSARIAL EXAMPLE), whereas if the threshold α is not exceeded (N), the input data sample INPUTi is considered to be another type of anomaly (ANOMALY).

The threshold α can for example be set using a similar technique to the one described above for the case of the threshold δ. For example, in some embodiments the threshold α is a threshold that is used to identify a change in the class.

While in the example of FIG. 12 the distance d(Hi(n+1),Hi1) is only calculated after the n reinjections have been performed, in alternative embodiments it would be possible to perform a distance calculation after each reinjection, each distance for example being calculated with respect to the previous output, i.e. d(Hi(n+1),Hi(n)). This distance, or entropy, is for example accumulated after each reinjection in order to calculate the overall distance d(Hi(n+1),Hi1). Additionally or alternatively, the differences d(Hi(n+1),Hi(n)) can be used to decide when to stop reinjection, and/or to decide early that an input sample corresponds to an adversarial example.

Furthermore, while in the example of FIG. 12 the adversarial example detection is based on Logits, more generally it could be based on any output of the hetero-associative function, including the predicted class. Indeed, a change of class is often indicative of an adversarial example.

Furthermore, while in the example of FIG. 12 the adversarial example detection is performed only in the case that the data is not detected as an anomaly, in alternative embodiments, the adversarial example detection could be performed systematically, for example in parallel with the general anomaly detection. In such a case, if either of the distance thresholds δ or α is exceeded, the data is flagged as an anomaly.

FIG. 13 illustrates a hardware system 1300 according to an example embodiment of the present disclosure. The system 1300 for example comprises one or more sensors (SENSORS) 1302, which are for example the same type of sensor as the sensors 520 of FIG. 5B, and for example comprise one or more image sensors, depth sensors, heat sensors, microphones, or any other type of sensor. The one or more sensors 1302 provide new stimuli data samples to a novelty detector (NOV. DET.) 1303, which for example comprises an anomalous detection system as described herein. This novelty detector 1303 for example provides the data samples to an incremental learning module (INC. LEARNING) 1304 or to an inference module (INFERENCE) 1306. In some embodiments, the novelty detector comprises the trained ANN having only an auto-associative function, and inferences are performed by the inference module 1306. For example, if the anomaly detection system of the novelty detector 1303 is configured to use Logits for the detection of adversarial examples, these are for example generated by the inference module 1306. Furthermore, like in the examples of ANNs described herein, in some cases the ANN of the inference module 1306 and of the novelty detector 1303 may have common parts. In some embodiments, the modules 1304 and 1306, and also in some cases the novelty detector 1303, are implemented by a CPU 1308 under control of instructions stored in an instruction memory (not illustrated in FIG. 13). Rather than a CPU, the system 1300 could alternatively or additionally comprise a GPU or NPU.

In operation, when a new data sample is received, it is for example processed by the anomaly detection system of the novelty detector 1303, optionally with input from the inference module 1306, in order to detect whether the data is an anomaly. During this processing, the output of the inference module 1306 to the actuators 1310 is for example put on standby until the anomaly detection response is available. This for example allows the system to only generate or modify a command to the actuators if the input data is identified as regular data.

For example, in the case that the novelty detector 1303 detects, based on its anomaly detection system, that the data sample is regular data, it provides it to the inference module 1306, where it is processed, for example in order to perform classification. In this case, an output of the inference module 1306 corresponding to a predicted label is for example provided to one or more actuators (ACTUATORS), which are for example the same type of actuator as the actuators 522 of FIG. 5, and are controlled based on the predicated label. For example, the actuators could include a robot, such as a robotic arm trained to pull up weeds, or to pick ripe fruit from a tree, or could include automatic steering or breaking systems in a vehicle, or operations of circuit, such as waking up from or entering into a sleep mode.

Alternatively, if anomalous data detection system of the novelty detector 1303 detects that the data sample is an anomalous data sample, the sample is for example added to an anomaly list (ANOMALY LIST) 1305 of the incremental learning module 1304. The module 1304 for example learns the new sample, along with other samples of the anomaly list, based on incremental learning. Incremental learning is a method of machine learning, known to those skilled in the art, whereby input data is continuously used to extend the models knowledge. For example, incremental learning is described in the publication by Rebuffi, Sylvestre-Alvise, et al. entitled “icarl: Incremental classifier and representation learning.”, Proceedings of the IEEE conference on Computer Vision and Pattern Recognition, 2017, and in the publication by Parisi, German I., et al. entitled “Continual lifelong learning with neural networks: A review.”, Neural Networks 113 (2019)54-71.

Various embodiments and variants have been described. Those skilled in the art will understand that certain features of these embodiments can be combined and other variants will readily occur to those skilled in the art. For example, while examples of a classification function have been described, it will be apparent to those skilled in the art that, in alternative embodiments, the principles described herein could be applied to other types of data processing function or algorithm that is not necessarily a classification function.

Finally, the practical implementation of the embodiments and variants described herein is within the capabilities of those skilled in the art based on the functional description provided hereinabove. For example, while examples have been described based on multi-layer perceptron ANN architectures, the description of the method proposed for anomaly detection applies more generally to any deep learning neural network (DNN) or convolutional neural network (CNN). For example, a dense part of a DNN or a CNN is constituted by an MLP as presented above. Furthermore, the principles described herein could also be applied to other families of neural networks including, but not restricted to, recurrent neural networks, reinforcement learning networks, etc. The described embodiments also apply to hardware neural architectures, such as Neural Processing Units, Tensor Processing Units, Memristors, etc.

1. A method of anomaly detection using a trained artificial neural network configured to implement at least an auto-associative function for replicating an input data sample at one or more outputs, the method comprising:
a) injecting, by a control circuit or processing device, an input data sample into the trained artificial neural network in order to generate a first replicated sample at the one or more outputs of the trained artificial neural network;
b) performing, by the control circuit or processing device, at least one reinjection operation into the trained artificial neural network starting from the first replicated sample, wherein each reinjection operation comprises reinjecting a replicated sample present at the one or more outputs into the trained artificial neural network;
c) computing, by the control circuit or the processing device, a first parameter based on a distance between a value of an nth replicated sample present at the one or more outputs resulting from the (n−1)th reinjection and a value of one of the previously injected or reinjected samples, where n is equal to at least 2; and
d) comparing the first parameter with a first threshold δ, and processing the input data sample as an anomalous data sample if the first threshold is exceeded.

2. A method of controlling one or more actuators, the method comprising:
performing anomaly detection according to the method of claim 1; and
controlling, by the control circuit or processing device, the one or more actuators only if the input data sample is not detected as an anomalous data sample.

3. The method of claim 1, further comprising, prior to a), capturing the input data sample using one or more sensors, wherein the one or more sensors comprise an image sensor, the input data sample being one or more images capture by the image sensor, and the control circuit or processing device being configured to perform said anomaly detection by image processing of the input data sample.

4. The method of claim 1, wherein the first parameter is an overall distance between the value of an nth replicated sample and a value of the input data sample.

5. The method of claim 1, wherein the first parameter is an average distance per reinjection among a plurality of distances associated with the n−1 reinjections, each of the plurality of distances corresponding to a distance between a value of the reinjected sample and the value of the replicated sample present at the one or more outputs resulting from the reinjected sample.

6. The method of claim 1, wherein the trained artificial neural network is configured to implement a classification function, one or more further outputs of the trained artificial neural network providing one or more class output values resulting from the classification function.

7. The method of claim 6, further comprising performing adversarial data detection by:
e) computing, by the control circuit or the processing device, a second parameter based on a distance between values of the one or more class output values present at the one or more further outputs resulting from a reinjection with values of the one or more class output values present at the one or more further outputs resulting from the injection of the input data sample; and
f) comparing, by the control circuit or the processing device, the second parameter with a second threshold, and processing the input data sample as an adversarial data sample if the second threshold is exceeded.

8. The method of claim 6, wherein the class output values are Logits.

9. The method of claim 1, wherein the computing the first parameter comprises computing one or more of:
the mean squared error distance;
the Manhattan distance;
the Euclidean distance;
the χ² distance;
the Kullback-Leibler distance;
the Jeffries-Matusita distance;
the Bhattacharyya distance; and
the Chernoff distance.

10. The method of claim 7, wherein the computing the second parameter comprises computing one or more of:
the mean squared error distance;
the Manhattan distance;
the Euclidean distance;
the χ\hat{ }2 distance;
the Kullback-Leibler distance;
the Jeffries-Matusita distance;
the Bhattacharyya distance; and
the Chernoff distance.

11. The method of claim 1, wherein processing the input data sample as an anomalous data sample comprises storing the input data sample to a sample data buffer, the method further comprising performing novel class learning on a plurality of input data samples stored in the sample data buffer.

12. A system for anomaly detection, the system comprising a control circuit or processing device configured to:
a) inject an input data sample into a trained artificial neural network in order to generate a first replicated sample at one or more outputs of the trained artificial neural network, wherein the trained artificial neural network is configured to implement at least an auto-associative function for replicating input samples at the one or more outputs;
b) perform at least one reinjection operation into the trained artificial neural network starting from the first replicated sample, wherein each reinjection operation comprises reinjecting a replicated sample present at the one or more outputs into the trained artificial neural network;
c) compute a first parameter based on a distance between a value of an nth replicated sample present at the one or more outputs after the (n−1)th reinjection and a value of one of the previously injected or reinjected values; and
d) compare the first parameter with a threshold, and processing the input data sample as an anomalous data sample if the threshold is exceeded.

13. The system of claim 12, further comprising:
one or more actuators, wherein the control circuit or the processing device, is configured to control the one or more actuators only if the input data sample is not detected as an anomalous data sample.

14. The system of claim 1213, further comprising one or more sensors configured to capture the input data sample, wherein the one or more sensors comprise an image sensor, the input data sample being one or more images capture by the image sensor, and the control circuit or the processing device is configured to perform said anomaly detection by image processing of the input data sample.

15. The system of claim 13, wherein the trained artificial neural network is configured to implement a classification function implemented by the inference module, one or more further outputs of the trained artificial neural network providing one or more class output values resulting from the classification function.

16. The system of claim 15, wherein the control circuit or the processing device is further configured to perform adversarial data detection by:
e) computing a second parameter based on a distance between values of the one or more class output values present at the one or more further outputs resulting from a reinjection with values of the one or more class output values present at the one or more further outputs resulting from the injection of the input data; and
f) comparing the second parameter with a second threshold, and processing the input data sample as an adversarial data sample if the second threshold is exceeded.

17. The system of claim 15, wherein the class output values are Logits.

18. The system of claim 12, further comprising a sample data buffer, wherein processing the input data sample as an anomalous data sample comprises storing the input data sample to the sample data buffer, the method further comprising performing novel class learning on a plurality of input data samples stored in the sample data buffer.
